(19) United States
(12) Patent Application Publication
(10) Pub. No.: US 2006/0288093 A1
(43) Pub. Date: Dec. 21, 2006

(54) System and method for information handling system custom application ordering and installation

(76) Inventors: Jefferson Raley, Austin, TX (US); Tim W. Cox, Austin, TX (US); Stacey Fox, Round Rock, TX (US); Kevin Hanes, Round Rock, TX (US); Christopher Harding, Round Rock, TX (US); Craig Rones, Austin, TX (US)

Correspondence Address: HAMILTON & TERRILE, LLP, P.O. BOX 203518, AUSTIN, TX, 78720, US

(21) Appl. No.: 11/141,229

(22) Filed: May 31, 2005

(51) Int. Cl. G06F 15/173

(52) U.S. Cl. 709/223

(57) ABSTRACT

Replacement of legacy information handling systems at a deployment site is automatically managed in cooperation with an information handling system manufacture site by coordinating the building of replacement information handling systems with appropriate configurations. An asset discovery tool interfaces with the legacy information handling systems through a deployment site network to discover the configurations of the legacy systems and communicates the legacy configurations to the manufacture site. An asset translation engine translates the legacy configurations to replacement configurations for building the replacement information handling systems. The ordering of replacement systems and the translation to the replacement configuration is managed by rules defined through an order tool of the deployment site and may include applications packaged at the deployment site and communicated to the manufacture site for installation on the replacement systems.

### BACKGROUND OF THE INVENTION

1. Field of the Invention

The present invention relates in general to the field of information handling system manufacture, and more particularly to a system and method for information handling system custom application ordering and installation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have become powerful tools for businesses and individuals in large part because of the flexibility available to configure systems for desired solutions. At a physical layer, a wide variety of components are available to build an information handling system within desired cost and capability constraints. For instance, computing capacity of a CPU, storage capacity and bus speed all vary based on the components selected for an information handling system with more powerful components generally having an increased cost. Thus, businesses and individuals often select information handling system physical configurations for specific tasks to balance the cost of the system with the complexity and importance of the tasks. At a software level, information handling systems are typically configured to run applications desired by the end user. For instance, a variety of operating systems are available to coordinate the operations of physical components in various environments, such as server versus desktop environments. Most information handling systems have common applications installed, such as word processing applications, as well as specific applications tailored to the needs of the user of the system.

One difficulty that arises from the flexibility of information handling systems is that businesses that have numerous systems tend to have difficulty tracking the configuration and use of their systems. Typically businesses hire information technology staff to help ensure the proper operation of information handling systems, including the integration of systems having a variety of configurations. Many information technology professionals plan their purchases of new and replacement information handling systems through build-to-order manufacturers. In the build-to-order manufacturing model, the customer specifies the configuration of software and hardware components and the manufacturer builds the information handling system to the customer's specifications. Build-to-order manufacturing is a powerful tool for information technology professionals to efficiently deploy information technology resources, however, the number of different systems involved in larger businesses can present an overwhelming logistical problem for ordering new and replacement systems. Once new or replacement systems arrive, information technology professionals often spend a significant amount of time configuring the system and installing applications specific to the system. This increases customer deployment costs in terms of complexity, internal labor, third party labor, hardware requirements, scheduling and lost end user productivity.

### SUMMARY OF THE INVENTION

Therefore a need has arisen for a system and method which automates the placement of orders for build-to-order information handling systems as replacements to legacy information handling systems.

In accordance with the present invention, a system and method are provided which substantially reduce the disadvantages and problems associated with previous methods and systems for building information handling systems to order. An asset discovery tool associated with a deployment site automatically discovers the configurations of legacy information handling systems at the deployment site and communicates the legacy configurations to a manufacture site. An asset translation engine associated with the manufacture site analyzes the discovered legacy configurations to define replacement configurations for building replacement information handling systems to order.

More specifically, a deployment site has plural legacy information handling systems interfaced with a network, each legacy system having a legacy configuration of hardware components and software applications. An asset discovery tool associated with the deployment location interfaces with the legacy information handling systems through the network to discover the legacy configuration for each legacy systems. The legacy configurations are stored in a discovered assets table and communicated to a manufacture site. An asset analyzer associated with the manufacture site analyzes the legacy configurations to generate proposed orders for one or more replacement information handling systems to replace one or more legacy systems with the orders confirmed by an order tool of the deployment site. An asset translation engine associated with the manufacture site translates the legacy configurations into replacement configurations by applying translation rules. The translation rules identify replacement components for legacy components based on preferences of the deployment site. The replacement configurations are used to build replacement information handling systems that are shipped from the manufacture site to the deployment site for replacement of the one or more legacy information handling systems.

The present invention provides a number of important technical advantages. One example of an important technical advantage is that automated asset discovery of networked information handling system resources allows a complete-picture analysis of a business' assets. Translation rules provide information technology professionals with suggested orders for replacement systems including updated hardware and a complete list of applications corresponding to existing systems. Automated tracking of replacement units to legacy systems ensures delivery of properly-configured systems to desired locations. The resources needed to install the replacement systems are decreased, thus saving time and money for the business.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for automated management of replacement of legacy information handling systems with automatically determined replacement configurations; and

FIG. 2 depicts a flow diagram of a process for automated management of replacement of legacy information handling systems with automatically determined replacement configurations.

### DETAILED DESCRIPTION

Replacement configurations for replacement information handling systems are translated from legacy configurations of networked legacy information handling systems at a deployment site with automated asset discovery. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

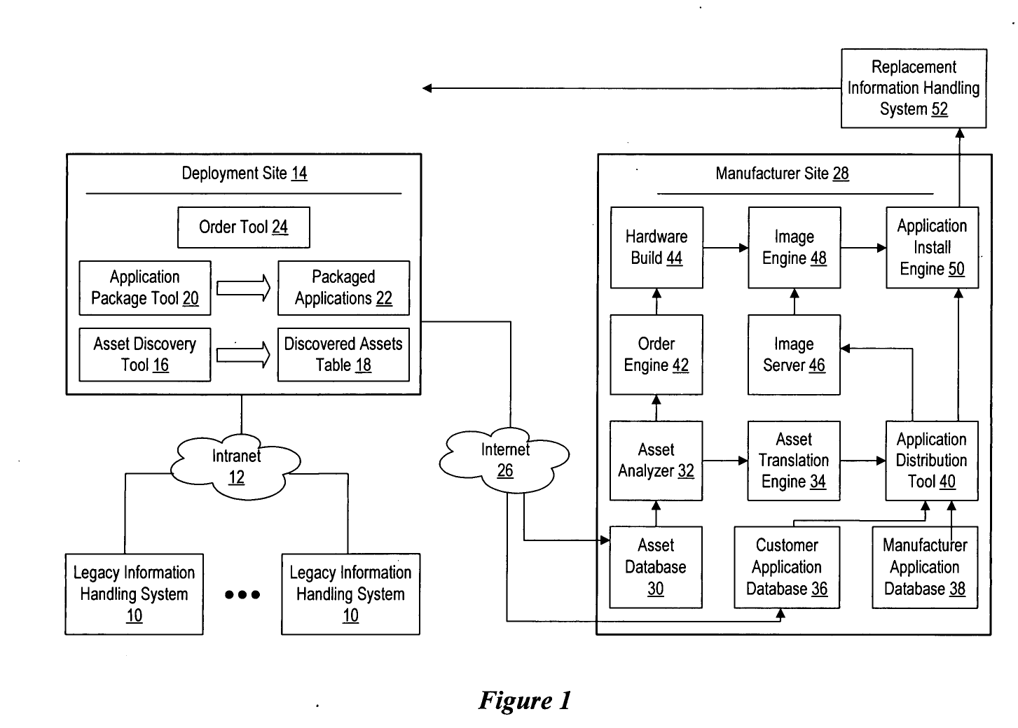

Referring now to FIG. 1, a block diagram depicts a system for automated management of replacement of legacy information handling systems with automatically determined replacement configurations. Legacy information handling systems 10 interface through an intranet 12 at a deployment site 14, such as a local area network server of a business organization. Deployment site 14 includes an asset discovery tool that queries legacy information handling systems 10 to determine their configurations and lists the discovered legacy configurations in a discovered assets table 18. For instance, asset discovery tool 16 is a commercially-available tool that automatically scans information handling systems interfaced with a network to collect hardware and software configurations of the systems, such as Absolute, Altitis, and Asset Metrix. Discovered assets table 18 is, for instance, a list of all legacy information handling systems by unique identifier with the hardware and software components loaded on each system. Deployment site 14 also includes an application package tool 20 that packages selected applications 22 located on legacy information handling system 10 for automated installation to other information handling systems, such as with SMS, Marimba, Managesoft, Altiris, and Novadigm.

Deployment site 14 interfaces through Internet 26 with a manufacture site 28 at which information handling systems are built to order. Manufacture site 28 is, for instance, a series of server information handling system servers that take and fulfill orders to build information handling systems to customer defined configurations. An asset database 30 of manufacture site 28 interfaces through Internet 26 with deployment site 14 to periodically retrieve discovered assets table 18. An asset analyzer 32 of manufacture site 28 analyzes the discovered assets table 18 from asset database 30 for each deployment site 14 being managed and applies rules to determine legacy information handling systems 10 that need replacement. For instance, order tool 24 defines rules to automatically generate proposed orders for replacement information handling systems based on the analysis of discovered assets table 18 and then approves submission of the orders for manufacture of replacement information handling systems. Rules for automated orders may depend on the needs of deployment site 14 and may include factors such as processor speed, system age, memory speed, available memory, networking capability or other parameters of importance to the business of the deployment site.

Once order tool 24 approves an order for manufacture, an asset translation engine 34 retrieves the legacy configuration of the one or more systems being replaced and translates the legacy configuration into a replacement configuration based on translation rules. For instance, predetermined versions of an operating system or application found on the legacy information handling system are replaced with defined replacement versions. Alternatively, predetermined settings in the legacy configuration result in the selection of defined replacement applications for the replacement configuration. As another example, legacy hardware components are mapped to replacement hardware components for building the physical system, such by CPU type, storage capacity or other component parameters. Customer specific applications, such as those packaged by application package tool 20, are stored in customer application database while more common commercially-available applications are stored in manufacture application database 38. In one embodiment, asset translation engine 34 compares applications of a legacy configuration with the applications in manufacture application database 38 and customer application database 36 and requests missing applications from application package tool 20. Applications identified for a replacement configuration are distributed to the manufacturing process by application distribution tool 40.

After the hardware and software configurations are determined for a replacement information handling system, an order engine 42 initiates assembly of the physical components at hardware build 44. The assembled replacement information handling system interfaces with an image server 46 and image engine 48 to have the software configuration copied to permanent storage, such as the firmware and hard disc drive. Image server 46 creates an image with applications received from application distribution tool 40. An application install engine 50 installs applications on the replacement information handling system that are not installed as part of the image. Once the software configuration is established at the replacement configuration determined by the asset translation engine 34, replacement information handling system 52 is shipped to deployment site 14. Through the build process, order tool 24 interacts with order engine 42 to monitor and, where desired by a customer, to approve manufacture selections.

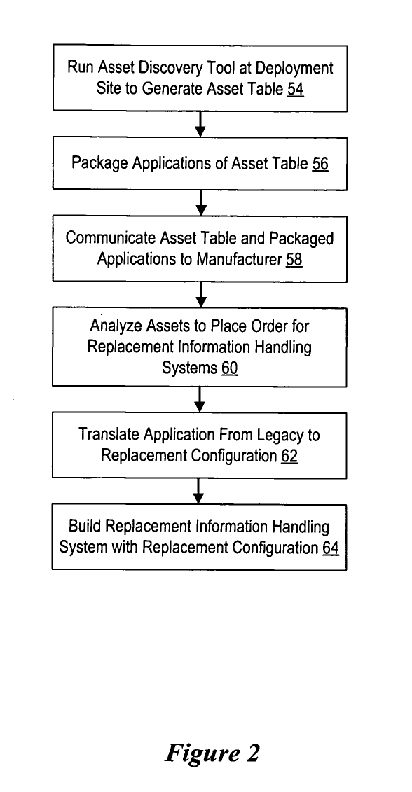

Referring now to FIG. 2, a flow diagram depicts a process for automated management of replacement of legacy information handling systems with automatically determined replacement configurations. The process begins at step 54 with the running of an asset discovery tool at a deployment site to generate a discovered assets table. For instance, the discovered assets table lists all legacy information handling systems interfaced with a network and, for each legacy system, lists the software applications and hardware components found by discovery. At step 56, applications in the discovered assets table that are not available at a manufacture site are packaged for communication to the manufacture site. At step 58, the discovered assets table and packaged applications are communicated from the deployment site to the manufacture site. At step 60, the discovered assets table is analyzed to determine orders to be placed for replacement information handling systems. For instance, rules defined by the customer associated with the deployment site are applied to identify one or more legacy systems in need of replacement. At step 62, the discovered assets for the legacy systems are translated from the legacy configuration to a replacement configuration. For instance, replacement hardware components are identified for assembly into a physical system and replacement software components are identified for imaging to the assembled replacement system. At step 64, the replacement information handling system is built-to-order to the replacement configuration and shipped to the deployment site.

Although the present invention has been described in detail, it should be understood that various changes, substitutions and alterations can be made hereto without departing from the spirit and scope of the invention as defined by the appended claims.

What is claimed is:

1. A system for managing replacement of legacy information handling systems interfaced with a network of a deployment site, the system comprising:
an asset discovery tool associated with the deployment site, the deployment site having plural networked legacy information handling systems, each legacy information handling system having a configuration, the asset discovery tool operable to automatically discover the configuration of the legacy information handling systems through the network to generate a discovered assets table;
an order tool associated with the deployment site and operable to communicate the discovered assets table to a manufacture site, the order tool further operable to order a replacement information handling system for one or more of the legacy information handling systems in the discovered assets table; and
an asset translation engine associated with the manufacture site, the asset translation engine operable to translate the configurations of the one or more legacy information handling systems into replacement configurations for building the replacement information handling systems.

2. The system of claim 1 wherein the configurations comprise a list of applications loaded on each legacy information handling system.

3. The system of claim 2 further comprising:
an application package tool operable to package selected applications discovered by the asset discovery tool and to communicate the packaged applications to the manufacture site; and
an application distribution tool operable to receive the packaged applications and to distribute the packaged applications to replacement information handling systems having a configuration with the packaged applications.

4. The system of claim 3 further comprising:
a customer application database operable to store the packaged applications; and
a manufacture application database operable to store predetermined common applications.

5. The system of claim 1 wherein the configurations comprise a list of hardware devices loaded on each legacy information handling system.

6. The system of claim 1 further comprising an asset analyzer associated with the manufacture site and operable to interface with the order tool, the asset analyzer further operable to analyze the discovered assets table to create a proposed order for replacement information handling systems for communication to the order tool.

7. The system of claim 6 wherein the order tool is further operable to define parameters for the asset analyzer to apply for analyzing the discovered assets table.

8. The system of claim 1 wherein the order tool is further operable to interface with the asset translation engine to define rules for the asset translation engine to translate legacy configurations into replacement configurations.

9. A method for managing replacement of legacy information handling systems interfaced with a network of a deployment site, the method comprising:
running an asset discovery tool at the deployment site to automatically discover the configuration of the legacy information handling systems through the network;
communicating the configurations of the legacy information handling systems to a manufacture site;
selecting one or more of the legacy information handling systems for replacement;
translating at the manufacture site the configuration of the selected legacy information handling system to a replacement configuration; and
building at the manufacture site the replacement information handling system with the replacement configuration.

10. The method of claim 9 wherein running an asset discovery tool further comprises discovering the hardware configuration of the legacy information handling systems.

11. The method of claim 9 wherein running an asset discovery tool further comprises discovering the software application configurations of the legacy information handling systems.

12. The method of claim 11 further comprising:
packaging one or more applications at the deployment site;
communicating the packaged applications to the manufacture site;
determining that a legacy configuration includes a packaged application; and
installing the packaged application on a replacement information handling system.

13. The method of claim 9 further comprising:
analyzing the discovered configurations to prioritize ordering of replacement information handling systems according to one or more predetermined factors; and
presenting the prioritized ordering at the deployment site.

14. The method of claim 13 further comprising:
setting the one or more predetermined factors from the deployment site.

15. The method of claim 9 further comprising:
setting at the deployment site one or more rules for translating legacy configurations to replacement configurations.
